(19) United States
(12) Patent Application Publication
(10) Pub. No.: US 2017/0316508 A1
(43) Pub. Date: Nov. 2, 2017

(54) System and Method for Processing Insurance Claims

(71) Applicant: John H. Seale, Dallas, TX (US)

(72) Inventor: John H. Seale, Dallas, TX (US)

(21) Appl. No.: 15/140,664

(22) Filed: Apr. 28, 2016

(51) Int. Cl. G06Q 40/08; G06Q 10/10; G06F 17/27

(52) U.S. Cl. CPC G06Q 40/08; G06F 17/2705; G06Q 10/1057

(57) ABSTRACT

The invention is directed to systems and methods for managing insurance claim data among an insured party, a primary insurer, and a plurality of secondary insurers. Exemplary methods include providing a claim processing module. The claim processing module receives a claim for benefits for the insured party and parses the received claim for services performed and a total obligation. The claim processing module retrieves primary insurance coverage rules, first secondary insurance coverage rules, and second secondary insurance coverage rules. The claim processing module applies the retrieved insurance coverage rules to the services performed and determines various combinations of coverage. The claim processing module determines an optimum net balance to the insured party by comparison of the total obligation minus the primary insurer obligation minus the first secondary insurer obligation with the total obligation minus the primary insurer obligation minus the second secondary insurer obligation.

### BACKGROUND

### Field of the Invention

The present invention relates to data processing, more specifically to more specifically to processing insurance claims across multiple insurance policies.

### Description of the Related Art

An insurance claim is a request for an insurance provider to assume financial responsibility for a loss covered by an insurance policy. Many different types of losses may be insured, such as damage to a vehicle or home, medical conditions, death, identity theft, loss of wages due to disability or unemployment, or any other type of insurable loss.

A service provider such as a doctor may be employed by the insured to provide medical treatment, an auto mechanic may be employed to repair a damaged vehicle, a building contractor may be employed to repair a damaged home. Many different types of service providers exist, and in some cases a single service provider may provide multiple services. For example, a single visit to a hospital may involve multiple services providers and multiple medical treatments. The amount of financial responsibility covered under an insurance policy (i.e., the amount of financial responsibility assumed by the insurance provider) is generally related to the specific services provided. Thus, an insurance claim typically lists the service(s) provided and the amount(s) billed by the service provider.

In some cases, the insurance provider only assumes partial financial responsibility for a given service, and the insured party is responsible for the remaining amount. For example, medical insurance policies typically require the insured party to pay a co-pay and/or deductible corresponding to a fixed amount or percentage of the medical bill. Further, one or more services included in the insurance claim may not be covered by the insurance policy, in which case the insurance provider may reject the uncovered portion of the insurance claim and defer full financial responsibility for the uncovered portion to the insured party.

In other cases, an insured party may be enrolled in multiple insurance policies of the same type, from the same and/or different insurance providers. For example, the insured party may be enrolled in two or more different health insurance policies. When an insured party is enrolled in multiple insurance policies of the same type (from the same and/or different insurance providers), one of the insurance policies is typically referred to as the “primary” insurance policy. The other insurance policies are then referred to as “secondary,” “tertiary,” etc. Generally, the primary insurance policy is the first recourse when filing an insurance claim. However, if the primary insurance policy does not cover the entire amount of the insurance claim, some or all of the remaining financial responsibility may be covered by a secondary insurance policy.

In cases where coordination of benefits is used, the burden generally falls on the insured party to determine the financial responsibility for the insurance claim. In some cases, the insured party (or a service provider on the insured party's behalf) may be required to file multiple insurance claim documents, for each insurance policy associated with the insurance claim. Nonetheless, the combination of filings for each insurance policy may be viewed as a single insurance claim. The use of multiple insurance policies for a single insurance claim is generally referred to as “coordination of benefits,” and allows the insured party to ultimately reduce their financial responsibility for the insurance claim.

### SUMMARY

The invention is directed to systems and methods for managing insurance claim data among an insured party, a primary insurer, and a plurality of secondary insurers. Exemplary methods include providing a claim processing module, the claim processing module being executed on a hardware processor. The claim processing module receives a claim for benefits for the insured party. The claim processing module parses the received claim for services performed, the insured party's identifying information, and a total obligation. The claim processing module parses the received claim for the insured party's primary insurance coverage, the insured party's first secondary insurance coverage, and the insured party's second secondary insurance coverage. The claim processing module then retrieves primary insurance coverage rules, retrieves first secondary insurance coverage rules, and retrieves second secondary insurance coverage rules. The claim processing module applies the retrieved primary insurance coverage rules to the services performed and determines primary insurance eligible services performed and primary insurance ineligible services performed. Next, the claim processing module calculates a primary insurer obligation amount based on the primary insurance coverage rules.

The claim processing module applies the retrieved first secondary insurance coverage rules to the primary insurance ineligible services performed and determines first secondary insurance eligible services performed and calculates a first secondary insurer obligation amount based on the first secondary insurance coverage rules. The claim processing module applies the retrieved second secondary insurance coverage rules to the primary insurance ineligible services performed and determines second secondary insurance eligible services performed and calculates a second secondary insurer obligation amount based on said second secondary insurance coverage rules.

The claim processing module determines an optimum net balance to the insured party by comparison of the total obligation minus the primary insurer obligation minus the first secondary insurer obligation with the total obligation minus the primary insurer obligation minus the second secondary insurer obligation.

These and other features, aspects, and advantages of the invention will become better understood with reference to the following description, appended claims, and accompanying drawings.

### BRIEF DESCRIPTION OF THE DRAWINGS

FIG. 1 shows a diagram of an embodiment of the invention as it may exist in usage;

FIG. 2 shows a diagram of an embodiment of a system according to the invention as it may exist in usage; and

FIG. 3 shows a view of an embodiment of a method according to the invention.

### DETAILED DESCRIPTION

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Frequently, patients err in their statements of coverage or have no clear understanding of which of the coverages available to them. In addition, many persons are covered by more than one plan of coverage and fail to disclose this information to either their medical care provider or their insurance carrier or claims administrator. The result of not naming the correct insurance provider(s) can decrease income to service providers, insurers, or an insured party or lead to substantial delays in payment of claims.

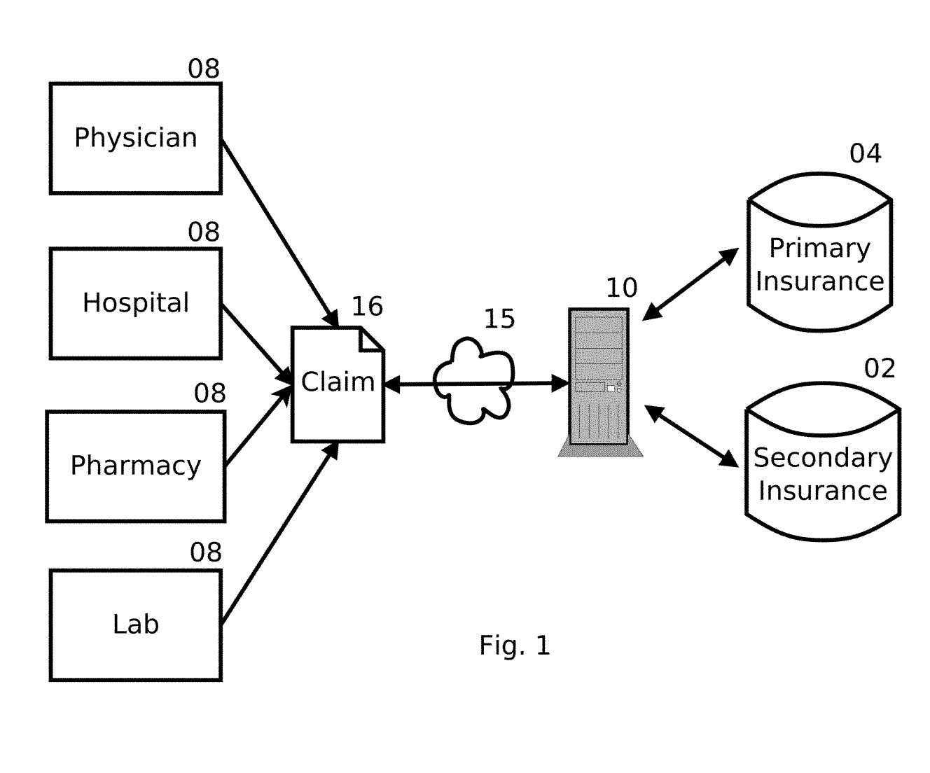

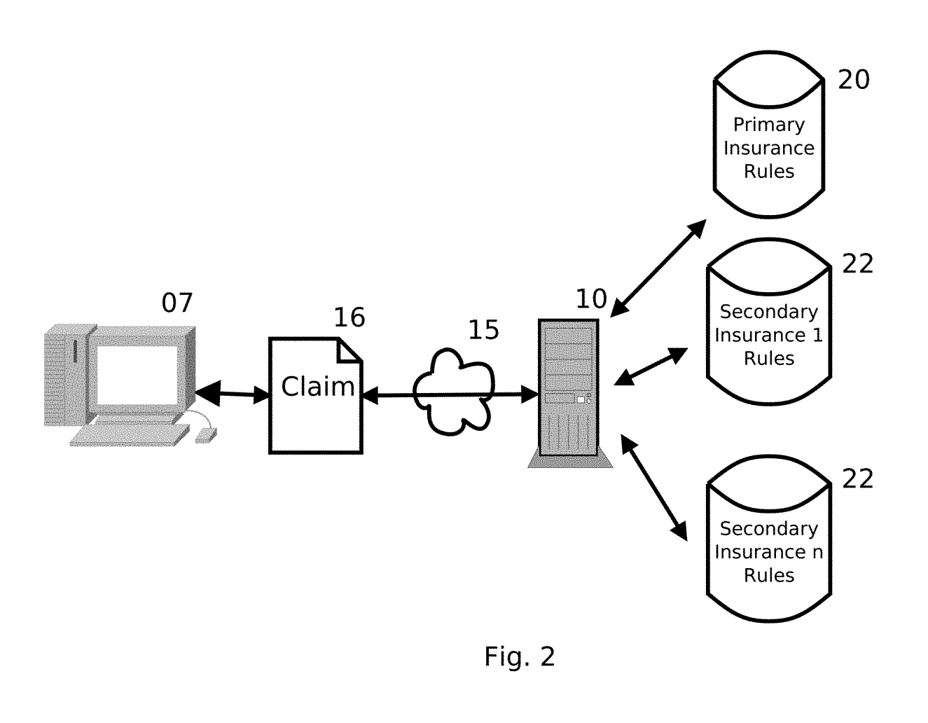

The present invention is directed to systems and methods for evaluation of primary and secondary liability among multiple sources and types of insurance or benefit plans. The embodiments enable automated comparison of claims to the sources of insurance for comparison of obligation among the insurers and the insured party. FIGS. 1 and 2 depict embodiments of systems according to the invention as it may exist in an operating environment. Depicted are services providers 08 using a claim processing computer 07 to submit a claim 16 to a clearinghouse server 11 over a network 15. The clearinghouse server 11 includes an insurance processing module 13 operable to process claim 16 and determine financial obligations among an insured party, a primary insurance provider 04, and one or more secondary insurance providers 02.

Typical insurance providers provide insurance programs such as as private coverage, workers compensation, and Medicare. An insured party can be an individual, a family, a business, and other type of insurable entities. Service providers 08 can include doctors, hospitals, pharmacies, laboratories, and other who provide services.

A claim 16 is a request for reimbursement under an insurance policy, in electronic format in exemplary process. For example, in a medical care venue, a claim 16 can include date of service rendered, diagnosis codes, care codes, various control codes, patient identification number, patient contact information, insurer identification number, and insured policy number. For example, insurance claim 16 data includes data describing insurance claims, such as the insurance policy's name, the insurance provider's name and/or contact information, the insurance claim number, the date of service, the service provider's name and/or contact information, the insured party's name and/or contact information, the type of service(s) provided, the amount billed for each service, any other type of data associated with insurance claims, or any combination thereof. An electronic insurance claim 16 may be in a format such as database, an extensible markup language (XML) file, a text file, a spreadsheet, or any other type of data repository.

Exemplary systems and methods of the current invention are carried out on computers. For example, claim 16 is carried out on a claim submission computer 07 and the claim processing module 13 is carried out on a clearinghouse server 11 in exemplary configuration. As used in the present disclosure, the term computer is intended to encompass any suitable processing device with a processor and memory. For example, although FIG. 1 illustrates a single computer, the environment may be implemented using one or more computers, as well as computers other than servers, including a server pool. Indeed, a server and client system may be any computer or processing device such as, for example, a blade server, general-purpose personal computer (PC), Macintosh, workstation, UNIX-based workstation, personal digital assistant (PDA), mobile phone, palmtop computer, tablet, or any other suitable device. In other words, the present disclosure contemplates computers other than general purpose computers, as well as computers without conventional operating systems. Further, the computer may be adapted to execute various operating systems, including Linux, UNIX, Windows, Mac OS, or other suitable operating system. A server is one that stores one or more applications, where at least a portion of the applications may be hosted applications executed via requests and responses sent to users or clients and communicably coupled to the illustrated environment of FIG. 1. Memory may include any memory or database and may take the form of volatile or non-volatile memory including, without limitation, magnetic media, optical media, random access memory (RAM), read-only memory (ROM), removable media, or any other suitable local or remote memory component. Memory may store various objects or data, including source code, object code, the scripting framework, classes, applications, jobs, databases, repositories storing inventory, shelving, robotics information, and any other appropriate information including any parameters, variables, algorithms, instructions, rules, constraints, or references thereto associated with the purposes of server. Certain systems include one or more clearinghouse server(s) configured to receive insurance claim 16 data over a network by a claim submission computer 07.

In general, in one aspect, the invention relates to a computer readable medium. The computer readable medium further comprises executable instructions for a processor and memory to carry out the processes of the current invention.

Network 14 may also include one or more local area networks (LANs), wide area networks (WANs), all or a portion of the Internet, and/or any other communication system or systems at one or more locations. Network 14 may be all or a portion of an enterprise or secured network, while in another instance at least a portion of the network may represent a connection to the Internet. Further, all or a portion of network may comprise either a wireline or wireless link. In other words, network encompasses any internal or external network, networks, sub-network, or combination thereof operable to facilitate communications between various computing components inside and outside the illustrated environment. The network may communicate, for example, Internet Protocol (IP) packets, Frame Relay frames, Asynchronous Transfer Mode (ATM) cells, voice, video, data, and other suitable information between network addresses.

The system includes specialized storage in the form of a database 20 22 configured to store insurance coverage data. The insurance coverage data can include insurer names, insurer identifier numbers, insurance policy types, insurance policy dates, insurance policy type identifiers, insurance policy coverage details, and the like. One skilled in the art would appreciated that the data may reside in one or more databases, tables, or computers. Representative suitable database systems include MySQL, PostgreSQL, SQLite, Microsoft SQL Server, Oracle, dBASE, XML, JSON, spreadsheet, text files, and the like.

The insurance coverage databases 20 22 receive and contain the insurance plan coverage data including updates as to the changes. The insurance coverage databases 20 22 also serve as a source of storage for the coordination of benefits rules which may be updated as necessary depending upon changes.

The system includes a claim processing module 13 operable to determine financial obligations among the insured party and insurers. As disclosed, a claim 16 data such as such as the insurance party's identifier and contact information, the insurer's identifier and contact information, the policy identifier, the date of service, codes for services, and the amount billed for each service. The claim 16 serves as the basis for the claim processing module 13 operable to determine financial obligations among the insured party and insurers. The claim processing module 13 is configured to receive the claim 16, retrieve associated insurance coverage information, determine coverage under the insurance plans for the services, and determine financial obligations among the insured party and insurers.

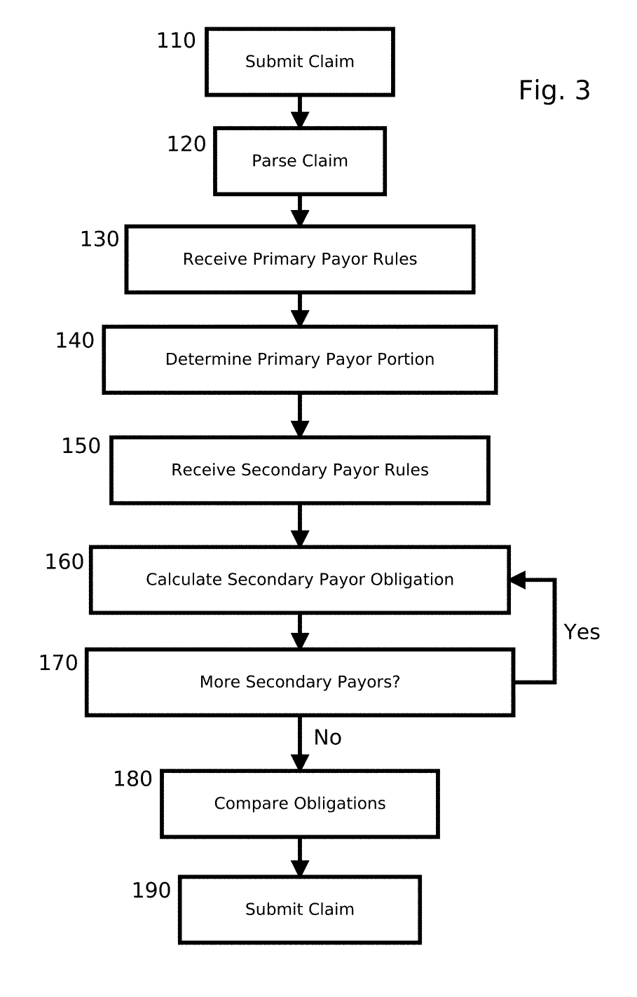

FIG. 3 depicts an embodiment of exemplary processing of insurance claims. In one or more embodiments, one or more of the steps shown in FIG. 3 may be omitted, repeated, and/or performed in a different order. At step 110, a claim is received. At step 120, the claim is parsed. At step 130, the primary payor's insurance coverage rules are received. At step 140, the primary payor's portion is determined. At step 150, a secondary payor's insurance coverage rules are received. At step 160, the secondary payor's putative obligations are determined. At step 170, iteration through the secondary payors occurs. At step 180, the secondary payor's putative obligations are compared. Based on the comparison, a claim is submitted 180. More consideration will be given to each of the steps below.

At step 110, the insurance claim 16 is received by the claim processing module 13. In certain embodiments, obtaining the insurance claim data involves a service provider 08 using a claim processor computer 07 to transmit a claim 16. The claim 16 includes services provided and fees for services provided. In certain embodiments, insurance claim 16 data associated with an insured party is obtained from one or more insurance servers, where one insurance server may be associated with a primary insurance provider, while another insurance server may be associated with a secondary insurance provider. Those skilled in the art will appreciate that a single insured party may have multiple insurance policies with the same insurance provider.

At step 120, the claim 16 is parsed for insured party information, insurer information, and services provided for checking insurance coverage of the individual services. The claim processor module 13 may use diagnostic and other coding as the basis for delineating services in order to determiner services provided. All of these tests may be implemented at the time medical service was rendered and/or at the time any or all of the above-listed sources of coverage processed claims from the injury at issue. The claim processor module 13 can use other separators or methods to delineate services provided.

Once the primary insurance 04, then it is necessary to recover the insurance coverage terms from database 20 as well as retrieve from historical records the insured party's account with the primary insurer including data such as paid deductibles, paid co-insurance and exhaustion of coverage limitations. This information is relayed to enable the claim processing module 13 to adjust the claim 16 item at issue in the inquiry against the coverage rules in the insured party's account to determine the net obligation of the insurer and the insured party on the particular medical service being queried.

At step 130, the claim processor module 13 receives the insurance coverage rules 20 for the primary insurer 04. In exemplary configuration, the insured party's identifier is used as a key to retrieve coverage information. For example, the claim 16 may include a patient identifier such as a social security number and/or other identifying code of each person having a right to benefits under any plan operated by the insurer. The effective date of coverage and termination are optionally retrieved under the coverage at issue, the plan number(s) under which such insured party is covered, and the nature of the coverage.

It is within the scope of this invention to receive enrollment and plan change information. For example, this claim information can include the identification number for the insurance plan coverage for each individual person and include that person's identification number together with the status or class of coverage under which the person is covered and the nature of the change from the previous information supplied for that person.

At step 140, the claim processor module 13 determines the primary insurer's financial obligation for the subject claim 16. One such data element for determining the nature of coverage are diagnostic and care codes of the claim 16. The diagnostic and care codes of the claim 16 can be compared to those of the primary insurance rules 16 for covered codes and amounts. For example, International Classification of Diseases (ICD), Current Procedural Terminology (CPT), Diagnosis-Related Group DRG or other codes for identifying care rendered can be employed as keys. In one or more embodiments, the pattern matching involves iterating through the insurance claim 16 data and comparing one or more designated fields in the insurance claim data. The claim processor module 13 applies the primary insurance rules to determine eligible services and ineligible services. Furthermore, a service may be eligible but not fully reimbursed. A determination is made as to whether the coverage terms for each remaining service exists under the subject secondary insurer. If the plan terms exist, then the codes are matched to the coded benefits and coverage found in the plan terms located in the primary insurance coverage database 20. The reimbursement amount is tallied to the financial obligation for the primary insurer. Where there is not 100% reimbursement or if no coverage is possible under the plan, the ineligible or partially eligible service line item is stored for later comparison under a secondary insurer's 02 rules. The total financial obligation for the primary insurer 04 is tallied.

Different insurance providers may agree on a standardized identity field, where related insurance claim data from different insurance providers includes the same identity field. Alternatively, for example, if an identity field is not available, other fields may be used to make a “best guess” determination that two or more insurance claim 16 data elements are related.

The claims processor module 13 may make an automated or telephonic inquiry to the insurer. The processing of payable amounts and remittances starts with the finding of the primary insurer 04.

After the primary insurer obligation has been calculated, any remaining claim amount passes on to determine if there is any secondary insurer 02 coverage to determine any amount payable under a secondary plan. Likewise, if any amount remains, it can be processed for tertiary, or any other ancillary sources of payment available under the coordination of benefits rules.

By checking this, the first step is to indicate if there is multiple coverage, that is, more than one source of coverage for a given insured party. At step 150, the claims processor module 13 receives a secondary insurer's coverage plan.

Different classes of coverage exist, for example, regular health insurance, and supplemental insurance which covers the otherwise uninsured risk of the insured party. Current rules of coordination allow for various levels of exactitude in assessing the sources of contribution on any given claim. Optimal coordination in the context of differing classes of insurance requires coordination on the basis of the medical service rendered. For example, where a standard commercial health insurance plan may omit coverage for vision services, a supplemental vision policy may cover these bills, and to be complete, the coordination of benefits test would preferably include a specification of the service rendered as compared to the services covered under each plan covering a given individual. Thus, where no detail is available, the instant process will identify all sources of insurance.

Where there are secondary insurers, the plan terms are retrieved from the secondary insurance rules database 22.

Then, at step 160, the claim processor module 13 determines the primary insurer's financial obligation for the subject claim 16, as disclosed above for the primary insurer, the coverage for remaining services provided or services not reimbursed 100% are processed for eligibility under the secondary insurance plan rules 22. The claim processor module 13 applies the primary insurance rules to determine eligible services and ineligible services. Furthermore, a service may be eligible but not fully reimbursed. A determination is made as to whether the coverage terms for each remaining service exists under the subject secondary insurer. If the plan terms exist, then the codes are matched to the coded benefits and coverage found in the plan terms located in the primary insurance coverage database 20. The reimbursement amount is tallied to the financial obligation for the primary insurer. Where there is not 100% reimbursement or if no coverage is possible under the plan, the ineligible or partially eligible line item is stored for later comparison under an alternate secondary insurer's 02 rules. The putative total financial obligation for the secondary insurer 04 is tallied.

At step 170, the claims processor module check for additional secondary insurers. If so, it iterates through steps 150 and 160 for the appropriate line items.

The claims processor module checks whether the codes match more than one plan and according to that test if the answer is no, that is the codes match only a single plan, then the decision is made as to whether coverage is possible under this plan. If no coverage is possible under the plan. The service item is stored for later comparison to other secondary insurance rules 22, or alternatively assigned as an insured party financial obligation.

If the codes match more than one plan then it may be necessary to to retrieve and apply the coordination of benefit rules. Then according to these rules, if coverage is possible as determined then the coordination of benefit rules are applied to determine if there is multiple coverage to which the coordination of benefit rules are applicable as indicated. If the answer is no, then a report of possible double coverage is made to the inquirer. If the multiple coverage is susceptible to the coordination of benefit rules and an affirmative action is obtained, then the computer applies the coordination of benefit rules to the multiple sources to determine a hierarchy of legal obligation to indemnify or cover the claims. If the application of these rules indicates only a single coverage, the answer is no and the source of the coverage is reported to the inquirer. If the answer is yes, then the coordination of benefit rules will rank the sources of coverage as primary, secondary, tertiary, etc. This entire ranking will be reported and the information stored.

In certain embodiments, the claim processing module 13 submits a claim to the primary insurer or a secondary insurer. In certain embodiments, the claim and supporting is submitting in order to receive a confirmation of the insurer obligation. Where the insurer returns an amount different than originally calculated, the claim processing module 13 may use the originally calculated financial obligation, the returned financial obligation, and/or an average, weighted or otherwise, for later steps. Where the insurer is not the insurer in the optimum combination or other suitable circumstances, the claim is reversed.

At step 180, the financial obligations of each of the parties, namely, the insured party, the primary insurer 04 and the secondary insurers 02 are compared. The claim processing module 13 iterates through the different primary insurer 04 and secondary insurer 02 combinations in order to determine the optimum combination. In exemplary configuration, the claim processing module 13 selects the combination resulting in the lowest net balance or financial obligation to the insured party. After the above has been calculated, the total amounts are tabulated and the computer processing module 13 then reports a statement of obligation to each party.

At step 190, a claim 16 is submitted based on the tabulated financial obligations. Optionally, a form of remittance is prepared to the service provider and a notice is sent to the insured party of the billing amounts including any remaining amount due directly from the insured party. The present invention can also electronically or on hard copy deliver accounts payable to the correct primary payor.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A system for determining financial responsibility among an insured party, a primary insurer and a plurality of secondary insurers, said system comprising:
a claim processing module, said claim processing configured to cause a hardware processor to perform the following;
receive a claim for benefits for said insured party;
parse said received claim for services performed, said insured party's identifying information, and a total obligation;
parse said received claim for said insured party's primary insurance coverage, said insured party's first secondary insurance coverage, and said insured party's second secondary insurance coverage;
retrieve primary insurance coverage rules, retrieve first secondary insurance coverage rules, and retrieve second secondary insurance coverage rules;
apply said retrieved primary insurance coverage rules to said services performed and determine primary insurance eligible services performed and primary insurance ineligible services performed;
calculate a primary insurer obligation amount based on said primary insurance coverage rules;
apply said retrieved first secondary insurance coverage rules to said primary insurance ineligible services performed and determine first secondary insurance eligible services performed and calculate a first secondary insurer obligation amount based on said first secondary insurance coverage rules;
apply said retrieved second secondary insurance coverage rules to said primary insurance ineligible services performed and determine second secondary insurance eligible services performed and calculate a second secondary insurer obligation amount based on said second secondary insurance coverage rules;
determine an optimum net balance to said insured party by comparison of said total obligation minus the primary insurer obligation minus the first secondary insurer obligation with said total obligation minus the primary insurer obligation minus the second secondary insurer obligation.

2. The system of claim 1, further comprising:
said claim processing module further configured to retrieve coordination of benefits rules and apply said retrieved coordination of benefit rules; and
said claim processing module further configured to adjust one of said primary insurer obligation, said first secondary insurer obligation, or said second secondary insurer obligation in response to said applied coordination of benefits rules.

3. The system of claim 1, wherein said claim processing module is configured to submit a claim for remittance to said first secondary insurer in order to receive a confirmation of said first secondary insurer obligation.

4. The system of claim 3, wherein said claim processing module is configured to reverse said claim for remittance where said optimum balance includes said second secondary insurer.

5. The system of claim 1, wherein said claim processing module is configured to receive services provided in the form of diagnostic codes or care codes selected from ICD, CPT, or DRG codes.

6. The system of claim 1, wherein said claim processing module is configured to receive said claim in a database, extensible markup language, or spreadsheet format.

7. The system of claim 1, wherein said claim processing module is configured to present a report listing the financial obligations of the insured party, the primary insurer, and one of said secondary insurers.

8. The system of claim 1, wherein said claim processing module is configured to submit a claim for remittance to said primary insurer and the secondary insurer resulting in the optimum balance calculation.

9. A method for determining financial responsibility among an insured party, a primary insurer and a plurality of secondary insurers, said method comprising the following steps:
providing a claim processing module, said claim processing module executed on a hardware processor;
said claim processing module receiving a claim for benefits for said insured party;
said claim processing module parsing said received claim for services performed, said insured party's identifying information, and a total obligation;
said claim processing module parsing said received claim for said insured party's primary insurance coverage, said insured party's first secondary insurance coverage, and said insured party's second secondary insurance coverage;
said claim processing module retrieving primary insurance coverage rules, retrieving first secondary insurance coverage rules, and retrieving second secondary insurance coverage rules;
said claim processing module applying said retrieved primary insurance coverage rules to said services performed and determining primary insurance eligible services performed and primary insurance ineligible services performed;
said claim processing module calculating a primary insurer obligation amount based on said primary insurance coverage rules;
said claim processing module applying said retrieved first secondary insurance coverage rules to said primary insurance ineligible services performed and determining first secondary insurance eligible services performed and calculating a first secondary insurer obligation amount based on said first secondary insurance coverage rules;
said claim processing module applying said retrieved second secondary insurance coverage rules to said primary insurance ineligible services performed and determining second secondary insurance eligible services performed and calculating a second secondary insurer obligation amount based on said second secondary insurance coverage rules;
said claim processing module determining an optimum net balance to said insured party by comparison of said total obligation minus the primary insurer obligation minus the first secondary insurer obligation with said total obligation minus the primary insurer obligation minus the second secondary insurer obligation.

10. The method of claim 9, further comprising the steps of:
said claim processing module retrieving coordination of benefits rules and applying said retrieved coordination of benefit rules; and
said claim processing module adjusting one of said primary insurer obligation, said first secondary insurer obligation, or said second secondary insurer obligation in response to said applied coordination of benefits rules.

11. The method of claim 9, wherein said claim processing module submits a claim for remittance to said first secondary insurer in order to receive a confirmation of said first secondary insurer obligation.

12. The method of claim 11, wherein said claim processing module reverses said claim for remittance where said optimum balance includes said secondary insurer.

13. The method of claim 9, wherein said services provided are in the form of diagnostic codes or care codes selected from ICD, CPT, or DRG codes.

14. The method of claim 9, wherein said claim is provided in a database, extensible markup language, or spreadsheet format.

15. The method of claim 9, wherein said claim processing module presents a report listing the financial obligations of the insured party, the primary insurer, and one of said secondary insurers.

16. The method of claim 9, wherein said claim processing module submits a claim for remittance to the primary insurer and the secondary insurer of the optimum balance calculation.

17. A computer program product encoded on a non-transitory, tangible storage medium, the product comprising computer readable instructions for causing one or more processors to perform operations for determining financial responsibility among an insured party, a primary insurer and a plurality of secondary insurers, said method comprising the following steps:
providing a claim processing module, said claim processing module executed on a hardware processor;
said claim processing module receiving a claim for benefits for said insured party;
said claim processing module parsing said received claim for services performed, said insured party's identifying information, and a total obligation;
said claim processing module parsing said received claim for said insured party's primary insurance coverage, said insured party's first secondary insurance coverage, and said insured party's second secondary insurance coverage;
said claim processing module retrieving primary insurance coverage rules, retrieving first secondary insurance coverage rules, and retrieving second secondary insurance coverage rules;
said claim processing module applying said retrieved primary insurance coverage rules to said services performed and determining primary insurance eligible services performed and primary insurance ineligible services performed;
said claim processing module calculating a primary insurer obligation amount based on said primary insurance coverage rules;
said claim processing module applying said retrieved first secondary insurance coverage rules to said primary insurance ineligible services performed and determining first secondary insurance eligible services performed and calculating a first secondary insurer obligation amount based on said first secondary insurance coverage rules;
said claim processing module applying said retrieved second secondary insurance coverage rules to said primary insurance ineligible services performed and determining second secondary insurance eligible services performed and calculating a second secondary insurer obligation amount based on said second secondary insurance coverage rules;
said claim processing module determining an optimum net balance to said insured party by comparison of said total obligation minus the primary insurer obligation minus the first secondary insurer obligation with said total obligation minus the primary insurer obligation minus the second secondary insurer obligation.

18. The computer program product of claim 17, further comprising the steps of:
said claim processing module retrieving coordination of benefits rules and applying said retrieved coordination of benefit rules; and
said claim processing module adjusting one of said primary insurer obligation, said first secondary insurer obligation, or said second secondary insurer obligation in response to said applied coordination of benefits rules.

19. The computer program product of claim 18, wherein said claim processing module submits a claim for remittance to said first secondary insurer in order to receive a confirmation of said first secondary insurer obligation.

20. The computer program product of claim 19, wherein said claim processing module reverses said claim for remittance where said optimum balance includes said secondary insurer.
